(19) United States
(12) Patent Application Publication
(10) Pub. No.: US 2014/0213372 A1
(43) Pub. Date: Jul. 31, 2014

(54) SYSTEMS AND METHODS FOR PROVIDING GAME GESTURES

(71) Applicant: Zynga Inc., San Francisco, CA (US)

(72) Inventor: Brian Liang, San Francisco, CA (US)

(73) Assignee: Zynga Inc., San Francisco, CA (US)

(21) Appl. No.: 14/170,000

(22) Filed: Jan. 31, 2014

Related U.S. Application Data
(60) Provisional application No. 61/759,223, filed on Jan. 31, 2013.

(51) Int. Cl. A63F 13/30

(52) U.S. Cl. CPC A63F 13/12
USPC 463/43

(57) ABSTRACT

A system, computer-readable storage medium storing at least one program, and a computer-implemented method for providing replay data is provided. User input can be received from a first client device of a first user. The user input can include a plurality of data samples representative of a gesture made by a first user making a game move. A compressed version of the user input can be generated. The compressed version includes coded data representative of the plurality of data samples. The coded data has a smaller data size than the plurality of data samples. Replay data can be provided to a second client device of a second user. The replay data can be based on the compressed version of the user input. The replay data can be configured to representationally simulate, at the second device, the gesture made by the first user.

### RELATED APPLICATION

This application also claims the priority benefit of U.S. Provisional Application Ser. No. 61/759,223, entitled “SYSTEMS AND METHODS FOR PROVIDING GAME GESTURES,” filed Jan. 31, 2013, the disclosure of which is incorporated by reference herein in its entirety.

### TECHNICAL FIELD

The present disclosure relates to games and applications in general and in particular to computer-implemented games. In an example embodiment, game gestures made by a player during gameplay may be provided to an opponent of the player.

### BACKGROUND

The popularity of computer-implemented games is increasing. Additionally, many computer-implemented games include a social component such that multiple users who have a social connection with one another may play each other remotely. Some games are turned-based games that provide asynchronous player interactions. For example, a first player may perform a move in an online game while a second player is offline. When the first player has completed a move, the game may alert the second player that the first player's turn has finished and that it is now the second player's turn. At a convenient time, the second player can log into the game and make a move using the updated game board or environment. Accordingly, the game can proceed with each player taking turns in a similar manner.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system for implementing various example embodiments;

FIG. 2 is a schematic diagram showing an example of a social network within a social graph, according to some embodiments;

FIG. 3 is a block diagram showing example components of a game networking system, according to some embodiments;

FIG. 4 is a schematic diagram showing an example of a system for providing game gestures, according to some embodiments;

FIG. 5 is a flowchart showing an example method of providing game gestures, according to some embodiments;

FIG. 6 is a schematic diagram showing an example of game gestures captured on a client device, according to some embodiments;

FIG. 7 is a flowchart showing an example method of generating compressed user input;

FIG. 8 is a flowchart showing an example method of providing replay data;

FIG. 9 is an interaction diagram illustrating an example use case of capturing and replaying user gestures made during a game;

FIG. 10 is a diagrammatic representation of an example data flow between example components of the example system of FIG. 1, according to some embodiments;

FIG. 11 is a schematic diagram showing an example network environment, in which various example embodiments may operate, according to some embodiments; and

FIG. 12 is a block diagram illustrating an example computing system architecture, which may be used to implement one or more of the methodologies described herein, according to some embodiments.

### DESCRIPTION OF EXAMPLE EMBODIMENTS

### Overview

Players of one or more computer-implemented virtual games may be provided with the ability to view game gestures made by an opponent. While the technology disclosed herein is described as relating to gestures associated with a game move made in a game, one of ordinary skill in the art will appreciate that similar gestures may be recorded and played back for any communication setting (e.g., gestures associated with keystrokes made by participants of a chat conversation).

When a player (“user”) of a computer-implemented game makes a move in the game, gestures associated with the game move that the player makes may be recorded by a game networking system of the game. Gestures made by the player may include any physical actions, movements, motions, and the like, associated with user inputs from the player. The player can provide user inputs via a touch screen, a computer mouse, a stylus pen, and the like input devices. For example, in a word-based game, if the player moves a letter tile from one location to another, the gestures associated with that game move may include information associated with the physical manner in which the player makes the move (e.g., clicking on the tile, dragging and dropping the tile, tapping and holding the tile, flicking the tile, the speed at which the tile is moved, the release of the tile, any touch or multi-touch inputs from the player, etc.), the physical orientation of the client device (e.g., if the client device is a mobile phone, the gesture may be the action of holding the mobile phone in a landscape or a portrait orientation), the physical movement of the client device (e.g., shaking the phone to perform at least a portion of the game move), and the like.

The gestures made by the player may be stored by the game networking system and provided to the player's opponent such that the opponent may be able to view the player's game move and the gestures leading up to and resulting in the game move. In some embodiments, the gestures may be provided to the player's opponent using any type of animation to indicate the gestures. For example, if the player tapped and held on to a tile, the opponent may see the tile highlighted for the duration that the player tapped and held the tile while the player was making the game move. Providing players with the ability to view their opponents' gestures associated with game moves enhances the social experience of playing games with other players and may add to the competitiveness of the game.

However, recording and storing gesture information consumes computing resources, such as data storage capacity. As such, capturing, recording, and playing back gestures may reduce the amount of computing resources available for other useful features of the game. In some situations, there may be a trade-off between providing gesture playback and providing other features of the game. Thus, there is a need for improved gesture playback systems and methods.

In one aspect, among others, of some embodiments described herein, gesture playback is provided that can efficiently use computing resources. For example, gesture playback systems can process and compress gesture information prior to storage. Compression may remove some of the information is not useful for representing the recorded gesture. Additionally, the structure and context of the gaming environment can be utilized to further reduce the amount of information needed to characterize the gesture for playback

### Example System

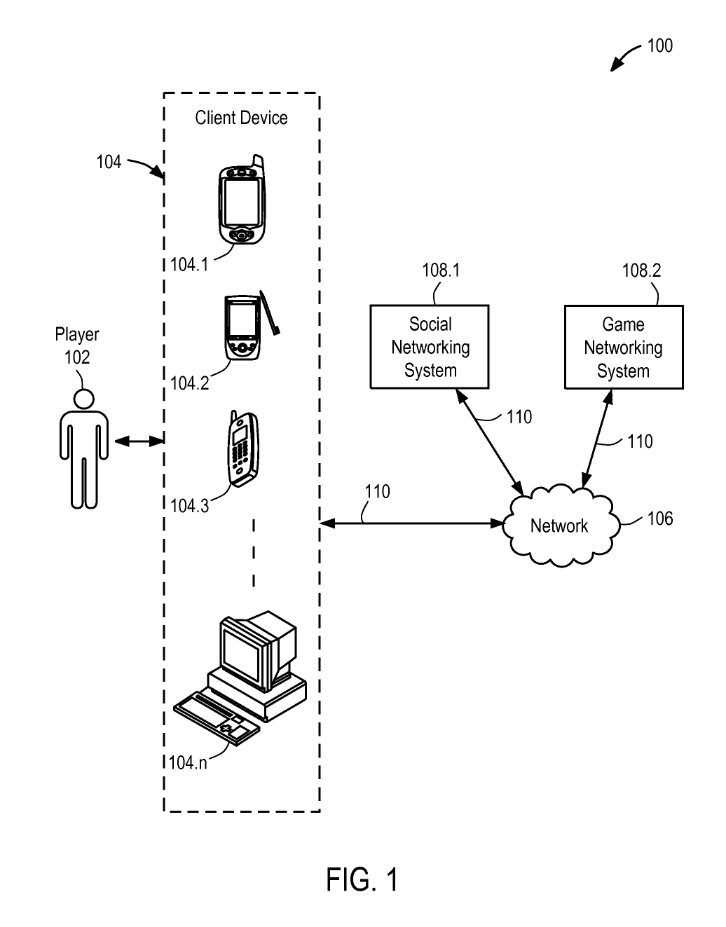

FIG. 1 is a schematic diagram showing an example of a system 100 for implementing various example embodiments. In some embodiments, the system 100 comprises a player 102, a client device 104, a network 106, a social networking system 108.1, and a game networking system 108.2. The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the social networking system 108.1 or the game networking system 108.2 directly, via the network 106, or via a third-party system. For example, the client device 104 may access the game networking system 108.2 via the social networking system 108.1.

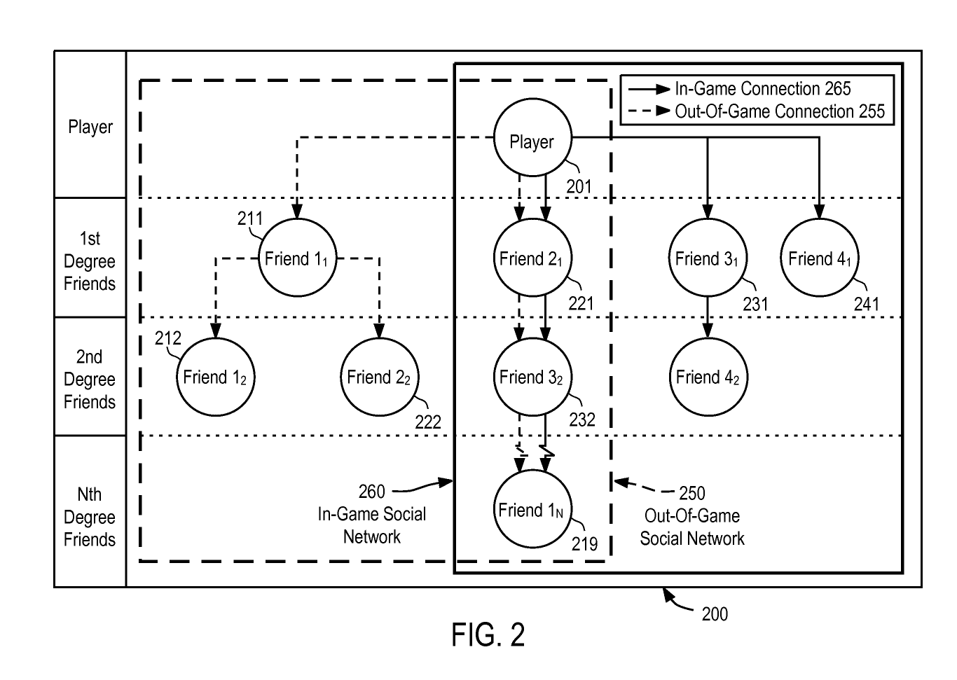

The social networking system 108.1 may include a network-addressable computing system that can host one or more social graphs (see for example FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online games. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2.

Although FIG. 1 illustrates a particular example of the arrangement of the player 102, the client device 104, the social networking system 108.1, the game networking system 108.2, and the network 106, this disclosure includes any suitable arrangement or configuration of the player 102, the client device 104, the social networking system 108.1, the game networking system 108.2, and the network 106.

FIG. 2 is a schematic diagram showing an example of a social network within a social graph 200. The social graph 200 is shown by way of example to include an out-of-game social network 250, and an in-game social network 260. Moreover, in-game social network 260 may include one or more players that are friends with Player 201 (e.g., Friend 231), and may include one or more other players that are not friends with Player 201. The social graph 200 may correspond to the various players associated with one or more virtual games. In an example embodiment, each player may communicate with other players.

### Examples of Providing Game Gestures

It is to be appreciated that the virtual gameboard for a game may be presented to a player in a variety of manners. In some embodiments, a game user interface associated with one or more computer-implemented games may be provided to a player via a client device of the player. The player may perform a variety of game moves by providing gestures using the game user interface.

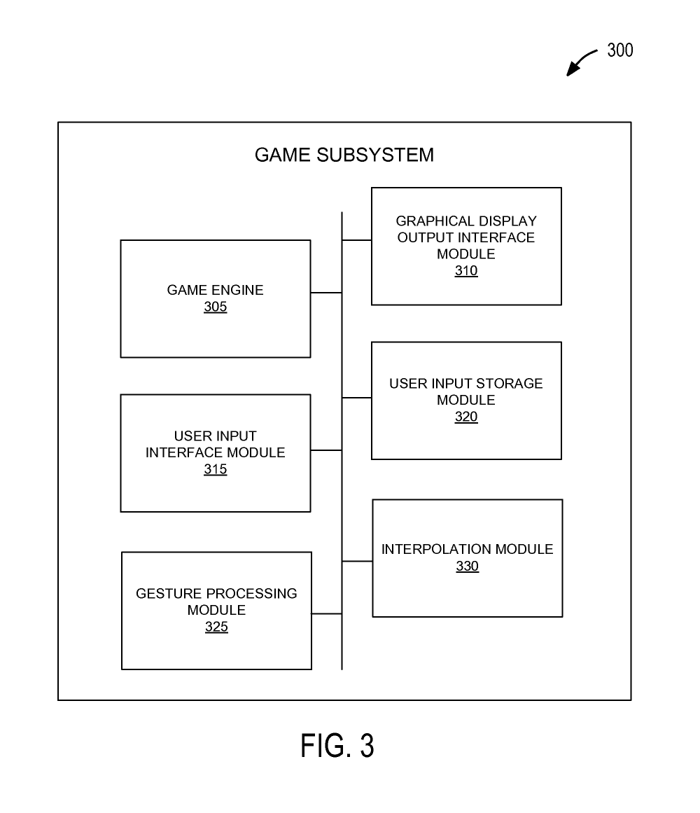

FIG. 3 is a block diagram showing example components of a game subsystem 300. The game subsystem 300 may include a game engine 305, a graphical display output interface module 310, a user input interface module 315, a user input storage module 320, a gesture processing module 325, and an interpolation module 330. In some embodiments, the components of the game subsystem 300 can be included by the game networking system 108.2 of FIG. 1. However, it will be appreciated that in alternative embodiments, one or more components of the game subsystem 300 described below can be included, additionally or alternatively, by other devices, such as one or more of the client devices 104 of FIG. 1.

The game engine 305 may be a hardware-implemented module which may manage and control any aspects of a game based on rules of the game, including how a game is played, players' actions and responses to players' actions, and the like. The game engine 305 may be configured to generate a game instance of a game of a player and may determine the progression of a game based on user inputs and rules of the game.

The graphical display output interface module 310 may be a hardware-implemented module which may control information or data that is provided to client systems for display on a client device. For example, the graphical display output module 310 may be configured to provide display data (including replay data) associated with displaying a game instance of a game, displaying a game user interface associated with one or more games, displaying game moves of a player, displaying gestures made by a player, and the like.

The user input interface module 315 may be a hardware-implemented module which may receive user inputs for processing by the game engine 305 based on rules of the game. For example, the user input interface module 315 may receive user inputs indicating functions, such as a game move made by a player, gestures made by the player, and the like.

The user input storage module 320 may be a hardware-implemented module which may store, manage, and retrieve information associated with user inputs received from a client device of a player. For example, the user input storage module 320 may store, manage, and retrieve game move information, gesture information, and the like. For example, the user input storage module 320 may store user input information at any particular frequency. In one example embodiment, the user input storage module 320 may store user input information at a rate of about every half second or in the range of every 0.25 seconds to about every 1 second.

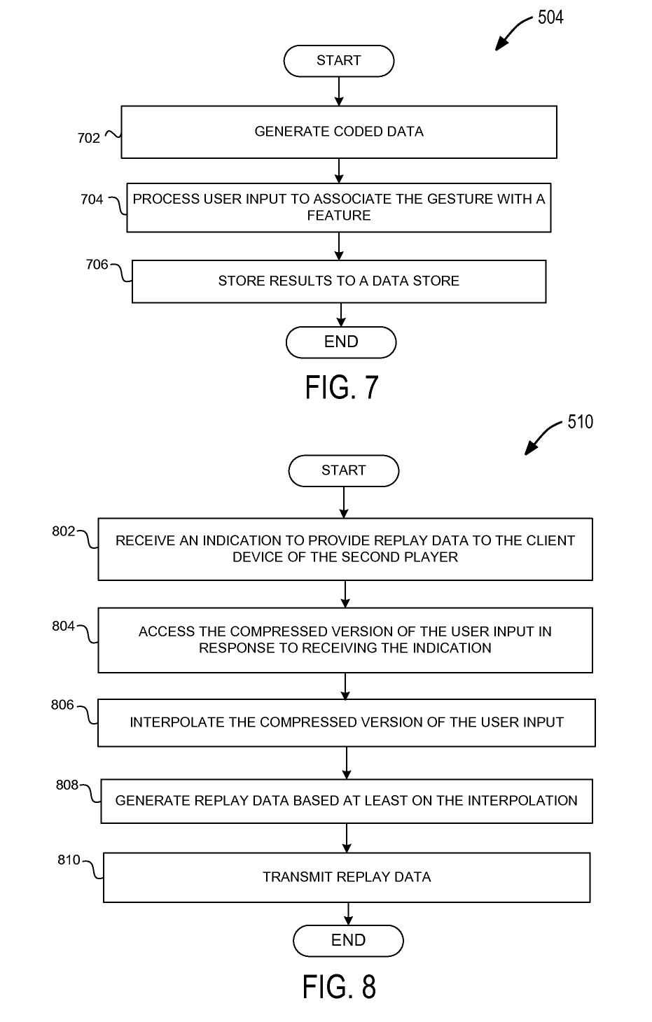

The gesture processing module 325 may be a hardware-implemented module which may process the gesture information stored by the user input storage module 320 so that the gesture may be presented to a player. For example, the gesture processing module 325 may process a gesture by compressing the amount of data used to represent the gesture. Data compression, as well as decompression (including interpolation), will be described later in greater detail in connection with FIG. 7. For example, the gesture processing module 325 may process a gesture by associating and providing any appropriate features associated with the gesture, such as sounds, visual elements (e.g., animations), and the like. In some embodiments, the functions of the gesture processing module 325 may instead be performed by the client device of a player. In this case, the client device may receive gesture information associated with user inputs and may use a gesture processing module on the client device to process the gesture information.

The interpolation module 330 may be a hardware-implemented module which may use the user input information received from a player's client device to interpolate game moves made by the player. As described above, the user input storage module 320 may store user input information at a frequency. The interpolation module 330 may use the user input information to interpolate additional information for any times for which user information was not stored so that seamless game moves may be provided to players.

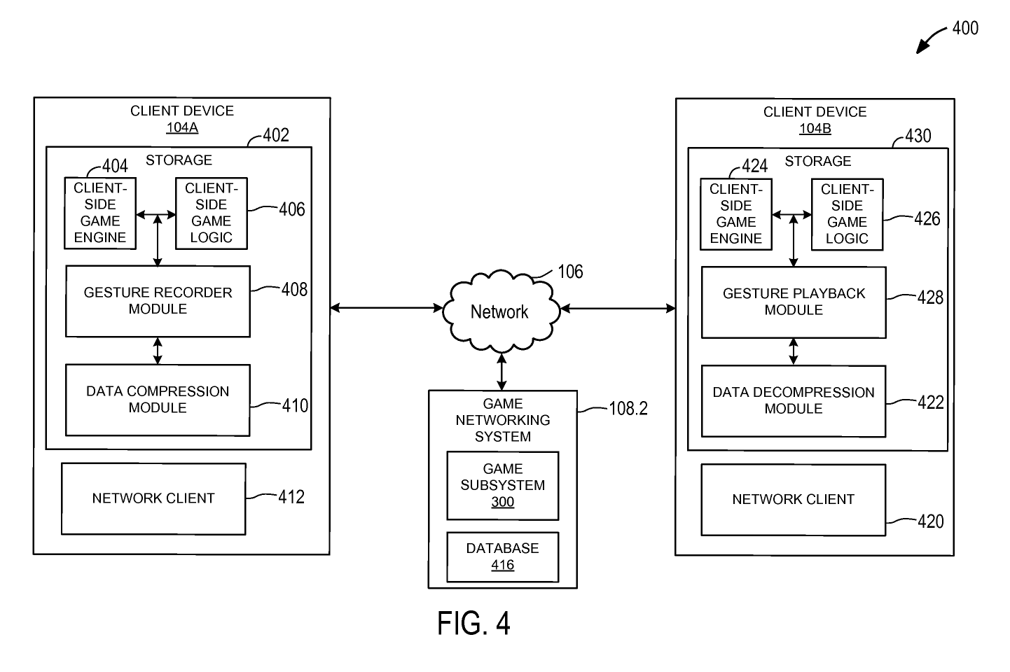

FIG. 4 is a schematic diagram showing an example of a system 400 for providing game gestures. The system includes first and second client devices 104A, 104B, a communication/computer network 106, and a game networking system 108.2. The first client device 104A includes data storage 402, a client-side game engine 404, a client-side game logic 406, a gesture recorder module 408, a data compression module 410, and a network client 412. The second client device 104B includes a network client 420, a data compression module 422, a client-side game engine 424, a client-side game logic 426, a gesture playback module 428, and data storage 430. The game networking system 108.2 includes a game subsystem 300, and a database 416. The data compression module 410 can correspond to a client-side embodiment of the gesture processing module 325 of FIG. 3. Additionally, the data compression module 422 can correspond to a client-side embodiment of the interpolation module 330. It will be understood that the functionality of data compression module 410 described herein can be performed by the gesture processing module 325 of the game subsystem 300 in alternative embodiments. Moreover, the functionality of the data decompression module 422 described herein can be performed by the interpolation module 330 of the game subsystem 300 in alternative embodiments.

In operation, the game gestures may originate from a first client device 104A of a player and may be presented on a second client device 104B of another player. When a game is initiated on the first client device 104A, the first client device 104A may access storage 402 of the first client device 104A, which may contain an application for the game. The application may include a game engine 404 that may process user inputs and present game features in response to the user inputs based on game logic 406 stored on the first client device 104A. The gesture recorder 408 may record gestures a player may make in the game. The data compression module 410 may compress game data associated with the player's gameplay, including any gesture data recorded by the gesture recorder 408. The network client 412 of the first client device 104A may send the compressed data, which may include replay data, to the server, where the data may be stored in the database 416 of the server.

The service module 418 of the server may manage gameplay between the player of the first client device 104A and the player of the second client device 104B. When the server receives data from the first client device 104A, the service module 418 may send the data, including the replay data, to the second client device 104B of the other player, which may be received by the network client 420 of the second client device 104B. The data may be decompressed by the data decompression module 422. When the other player accesses the game application stored in the storage 430 of the second client device 104B, the application may use the game engine 424 and game logic 426 stored on the target client device to initiate the replay of gestures. The gestures of the player of the first client device 104A may be replayed on the second client device 104B by the gesture playback module 428 using the replay data.

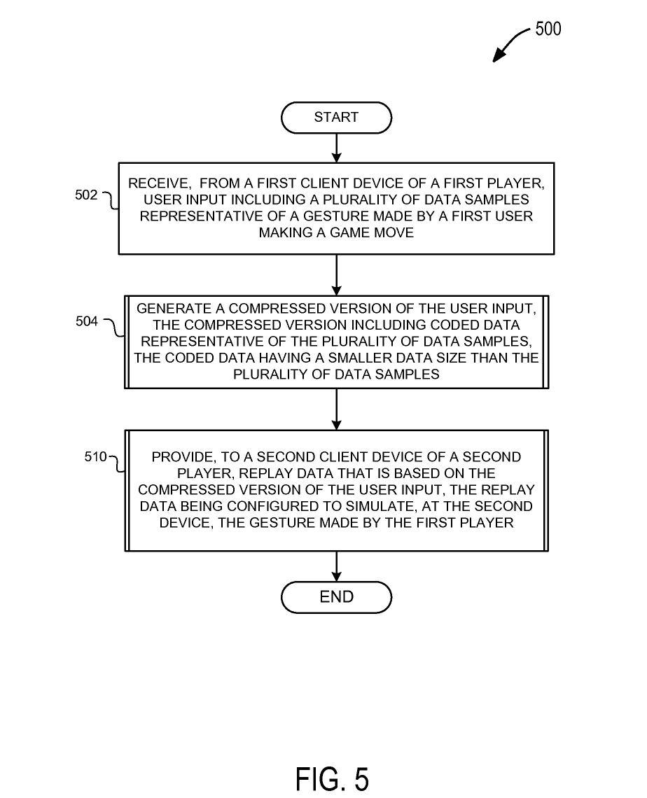

FIG. 5 is a flowchart showing an example method 500 of providing gesture replay data in a game between first and second players. In some embodiments, the method 500 may be performed using the game networking system 108.2 shown in FIG. 3. In this example embodiment, the method 500 may include operations such as receiving user input 502, storing the user input 504, receiving an indication 506, accessing the user input 508, and providing user interface output data 510. The example method 500 will be described, by way of explanation, below as being performed by certain modules. It will be appreciate, however, that the operations of the example method 500 can be performed in any suitable order by any number of the modules shown in FIG. 3. It will further be appreciated that not all the operations of the example method 500 are necessary and in alternative embodiments one or more operations may be omitted.

In operation 502, the method 500 includes receiving user input from a client device of a first player. The user input can include a plurality of data samples representative of a gesture made by the first user making a key move. Additionally, the user input may also include game move information. For example, the user input interface module 315 may receive, from the client device of the first player, the user input. In an embodiment, the client device 104a of FIG. 4 can transmit the user input over the network 106 to the game subsystem 300 of the game networking system 108.2 The game move information received may be any information associated with the movement of game objects the first player's moves in the game (e.g., moving a letter tile from one location to another). As described above, the gesture information received may be any information associated with any physical actions, movements, motions, and the like, associated with user inputs from the first player (e.g., the manner in which the player makes a game move, the movement of the client device during a game move, the orientation of the client device during a game move, etc.). The user input may be received from the client device via any appropriate manner (e.g., via Extensible Markup Language (XML), JavaScript Object Notation (JSON), etc.).

In operation 504, the example method 500 includes generating a compressed version of the user input. The compressed user input can include coded data, which include data that represents the gesture by using less data than the plurality data samples of the user input. The coded data can be generated by processing (e.g., compressing) the plurality of data samples such that the coded data contain less data than the plurality of data samples of the user input. The coded data can be generated by any compression method, as will be described later in greater detail below in connection with FIG. 7.

The operation 504 can include determining whether a data sample of the user input is to be used for coding or to be disregarded. The determination can be based on any rule suitable for retaining sufficient gesture information for capturing, detecting, and replaying game moves and/or gestures. For example, as described above, the user input storage module 320 can store received user input at particular frequency. Thus, the data samples provided at a rate above the particular frequency can be disregarded (e.g., downsampled). Additionally or alternatively, in some embodiments, the gesture processing module 325 processes the received user input by comparing a received user input with a previously received and stored user input. If, for example, no user input is received for a particular length of time, or if the user input received is substantially unchanged from the last user input received and stored, any information captured during that time or any unchanged information may not be stored and may be disregarded. The user input is (e.g., stored or quoted) stored if, instead, the time between receiving the user input storing the previous user input is greater than a threshold, and/or if the comparison (e.g., as determined by a difference) of the received user input to a previously stored user input is greater than a threshold. Discriminately coding/storing user input as stated above can serve to prevent the display of pauses in game moves and gestures made by a player, as well as serve to reduce data storage. A method of the operation 504 will be described in greater detail later in connection with FIG. 7.

In operation 510, the method 500 can include providing replay data to a second client device of a second player. The replay data can be based on the compressed version of the user input. Furthermore, the replay data can be configured to simulate, at the second device, the gesture made by the first player. For example, a gesture can be representationally simulated by displaying an object in the game moving in a trajectory similar to the trajectory of a finger-swipe gesture. Additionally, the second client device may actuate mechanically to simulate the orientation or movement of the first client device during a gesture. For example, piezoelectric devices may actuate in a manner that causes forces to act on the second client device to representationally simulate a tilting gesture performed by the first player.

The graphical display output interface module 310 may use the accessed user input (and in some embodiments, the interpolated game moves) to provide, to the client device of Player B, display data to display the game move with the gesture. In some embodiments, the game move and the gestures may be displayed as an animation indicating the gesture associated with the game move (e.g., highlighting the object being moved, changing the orientation of the gameboard of the game to reflect the orientation of Player A's client device, etc.). In some embodiments, the second player may request the playback of the first player's game moves and gestures, or the first player's game moves and gestures may be automatically played back on the second player's client device when the second player accesses the game. A method of operation 510 will be described in greater detail later in connection with FIG. 8.

Providing, to a second client device of a second player, replay data that is based on the compressed version of the user input, the replay data being configured to representationally simulate, at the second device, the gesture made by the first player

In some embodiments, the replay data may be user input information that is processed by the gesture processing module 325 such that the replay data includes data associated with any appropriate features associated with the gesture (e.g., sounds, visual elements, etc.).

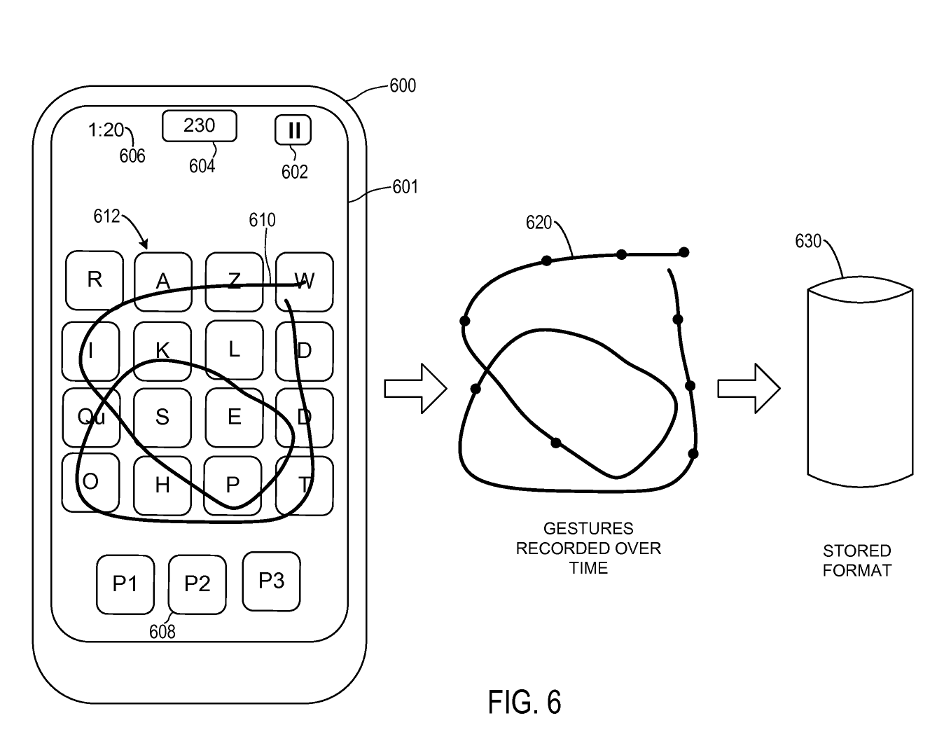

FIG. 6 is a schematic diagram showing an example of game gestures captured on a client device 600. The client device 600 may display a user interface 601 associated with the game being played. The user interface 601 may include a play or pause button 602, a score portion 604 indicating the player's score, a time portion 606 indicating the remaining amount of time left in the game being played, and a player button 608. The player button 608 may be used to select the player whose gestures should be displayed on the client device 600. For example, if first player is playing on the client device 600, first player may select player button 608 to view a replay of second player's gestures. In the example of FIG. 6, first player may be playing a game and the gesture recorder of the client device 600 may capture first player's gestures 610, such as a finger swipe on over the interactive objects 612 of the game. The gestures 610 may include data associated with any gestures made by the player while playing the game. In the example of FIG. 6, the gestures 610 show that the user submitted an input that includes dragging the user's finger across the touch screen in the manner shown by gesture 610. The client device 600 may provide user input associated with the recorded gesture 620.

The data samples corresponding to the gesture 620 recorded by the user interface 601 may include a large amount of data and, as such, many use a significant portion of game's resources. To reduce the use of game resources, the recorded gesture 620 may be compressed and stored in the compressed, coded format. For example, the recorded gesture 620 may be processed to generate coded data representing the recorded gesture 620 at a reduced data size. In an illustrative example, the recorded gesture 620 can be coded by representing the gesture 620 with one or more data samples (e.g., denoted by the black dots in FIG. 6), which can correspond to sampling the gesture at a reduced sampling rate as compared to the sampling rate of the user interface 601. The recorded gesture 620 can be coded in other suitable ways that represent the gesture 620 sufficiently for generating playback data. Once generated, the coded data of the recorded gesture 620 can be stored in a database 630 for later retrieval, decompression, and playback.

Data compression need not performed by the game server. In one embodiment, the client device 600 can generate the compressed version of the gesture 610 (e.g., using compression module 410). The client device 600 can transmit the compressed version to a game server for storage. In response to an indication to transmit replay data, the game server may send the compressed data to a second client device corresponding to the first player's opponent so that the game gestures may be simulated for the player's opponent. In this case, the second client device can perform the process of uncompressing the compressed data (e.g., using the compression module 422) for producing the simulation of the gesture 610.

FIG. 7 is a flowchart showing an example method 504 of generating compressed user input. In this example embodiment, the method 504 may include operations such as generating coded data 702, processing user input to associate the gesture with a feature 704, and storing results to a data store 76. The example method 504 will be described, by way of explanation, below as being performed by certain modules of FIG. 3. It will be appreciate, however, that the operations of the example method 504 can be performed in any suitable order by any number of the modules shown in FIG. 3. It will further be appreciated that not all the operations of the example method 504 are necessary and in alternative embodiments one or more operations may be omitted.

In operation 702, the method 504 can include generating coded data. For example, the gesture processing module 325 can be configured to receive user input from the user input interface module 310 for generating a compressed version of the user input. As stated, the user input includes the recorded gesture, such as a plurality of data samples representative of the gesture made by a first user making a game move. The compressed version of the user input includes coded data representative of the plurality data samples, at a reduced data size.

In one example embodiment, the user input interface module 310 can generate the coded data by selecting a subset of the plurality of data samples of the user input. The selection can performed using a variety of different rules. For example, the user input interface module 310 can generate the coded data by downsampling the recorded gesture at a reduced sampling rate, for instance, as compared to the sampling rate used by the user interface. In an example embodiment, the gesture processing module 325 down samples the recorded gesture to a sampling period in the range of about 0.25 seconds to about 1 second.

The sampling rate can be fixed are dynamically varied. For example, the downsampling rate can be automatically varied in response to characteristics of the user inputs. For example, slow-moving gestures (e.g., gestures having a rate of change less than a predetermined threshold) may be downsampled to a lower sampling rate than sampling rates for faster moving gestures. Accordingly, the gesture processing module 325 can be configured to adjust the sampling rate used to generate the compressed user input based on the results of monitoring the rate of change of the gesture during operation. For example, the gesture processing module 325 can be configured to determine a rate of change of the gesture as indicated by the user input, and to adjust a downsampling rate based on the determined rate of change where in increase in the rate of change of the gesture can cause an increase in the sampling rate.

In another example embodiment, the user input interface module 310 can select the subset of the gesture data samples based on a relationship of the gesture and the gaming environment. For example, the compressed version of the user input can be generated by selecting data samples of the gesture that are representative of locations about which the gesture interacted or overlapped with objects displayed within the game. As an illustrative example, turning back now momentarily to FIG. 6, the gesture 610 can be sampled whenever the gesture 610 satisfies some relationship with the interactive objects (such as the letter tiles 612) of the user interface 601. For example, the gesture 610 can be sampled if the gesture 610 crosses over a border of one of the tiles 612. These crossing points, being a subset of the data samples of the recorded gesture 620, can form coded data.

In another embodiment, the gesture processing module 325 can be configured to adjust the downsampling rate based on a state of the gaming environment. For example, the game can operate in a plurality of different modes for states, such as a combat mode, a driving mode, or a social interaction mode, as examples. The gestures of each of these modes they tend to produce gestures having different characteristics. For example, a combat mode may receive faster moving gestures than a social interaction mode. Accordingly, in an example embodiment, the gesture processing module 325 can configured to determine a mode of the game and two adjust a downsampling rate based on the mode.

And yet another embodiment, the gesture processing module 325 can be configured to generate the compressed version of the user input by curve fitting the data samples representing the gesture. A number of gestures have smooth movements and trajectories, such as, but is not limited to, the trajectory of swiping a finger across a surface of the device to move a tile. As such, these gestures can be suitable for approximating their trajectories with one or more functions. In one example embodiment, the trajectory of the gesture can be approximated by a polynomial function once the coefficients of the polynomial function have been determined. The coefficients of the polynomial function can be determined by curve fitting the polynomial function to the data samples. For example, the gesture processing module 325 can be configured to determining one or more parameters of a function based on comparing evaluations of the function to two or more of the plurality of data samples. The coefficients of the function may take up less data space than the data samples of the gesture. By using the coefficients of the polynomial to represent the gesture rather than the data samples, data storage may be reduced.

As stated above, the gesture processing module 325 can determine whether or not a data sample of the user input is to be coded and/or stored based on the difference between the data sample and a previously stored data sample. For example, the gesture processing module 325 configured to compare a first data sample to a second data sample, where the first data sample has been stored. If the comparison of the first data sample and the second data sample is greater than a threshold, then the second data sample is to be stored or coded. Otherwise, the second data sample is to be disregarded.

And yet another embodiment, the gesture processing module 325 can be configured to determining a relevance of the plurality of data samples to the gesture. For example, the user input may include game move information that provides an indication of the type of move performed by the user. Based on the game move information, the gesture processing module 325 can compare the data samples of the user input to one or more template gestures stored in a database. The template gestures can represent various gestures that can be performed in conjunction with the ended the game move indicated by the game move information. To determine relevancy of the data samples of the user input, the gesture processing module 325 can be configured to determine a degree that the data samples match one of the templates. If there is a match, then the gesture processing module 325 can generate coded data that corresponds to indication of the matching template. In some embodiments, the gesture processing module 325 can also provide additional indications of characteristics of the gesture in the context of the matching templates, such as, but is not limited to, speed and dimensions of the gesture.

In operation 704, the method 504 can include processing user input to associate the gesture with a feature. Features can include at least one of a sound or an animation. In an example embodiment, the gesture processing module 325 can be configured to determine the feature based on user input provided via the user input interface module 315. The gesture processing module 325 can determine the feature associated with the gesture based on, for example, the type of move associated with the gesture. For example, a gesture that is used to move and drop an interactive object displayed within the game can be associated with sounds associated with moving and dropping such an object. In another example, characteristics of the gesture can be determined and used to associate the gesture with certain features. For example, fast-moving gestures may be associated with features that include rapid, fast paced music. Associating features with the gestures can be used to create tension and to provide the players a way to be creative.

In operation 706, the method 504 can include storing the results to a data store. For example, the user input storage module 320 can receive the compressed user input and/or features associated with the gesture and store such data in a database, such as the database 416 of FIG. 4. For example, the user input received at operation 504 can be stored in any non-transitory tangible computer-readable medium. In one example embodiment, the user input storage module 320 of FIG. 3 may store the user input, including storing the game move information and the gesture information, received from the client device of the first player.

FIG. 8 is a flowchart showing an example method 510 of providing replay data. In this example embodiment, the method 510 may include operations such as receiving an indication to provide the replay data 802, accessing the compressed version of the user input 804, interpolating the compressed version of the user input 806, generating replay data based at least on the interpolation 808, and transmitting the replay data 810. The example method 510 will be described, by way of explanation, below as being performed by certain modules of FIG. 3. It will be appreciate, however, that the operations of the example method 510 can be performed in any suitable order by any number of the modules shown in FIG. 3. It will further be appreciated that not all the operations of the example method 510 are necessary and in alternative embodiments one or more operations may be omitted.

In operation 802, the method 510 includes receiving, from the client device of the second player, an indication to provide the replay data associated with the game to the client device of the second player. In an example embodiment, the indication can be received by the user input interface module 315 of FIG. 3. For example, the client device 104B can transmit the indication over the network 106 to the user input interface module 315 of the game networking system 108.2

The indication can be received from the client device of the second player if the second player's client device is ready to receive replay data. The indication can be provided in a manner suitable for “push” and/or “pull” schemes for providing replay data to the second player. For example, in some embodiments, the user input interface module 315 can transmit a push notification to the client device of the second player after the first player finishes their turn, and the client device of second player may, in response to receiving the push notification, transmit the indication to provide the game move and the gesture. In this way, the indication serves as an acknowledgment to the user input interface module 315 that the client device of the second player is ready to have replay data transmitted to the device of the second player. Additionally or alternatively, in a pull scheme, the client device of the second player can be configured to transmit the indication to the user input interface module 315 in response to the second player accessing the game and/or in response to the second player requesting that the first player's game moves and gestures be displayed, and/or the like events. In this way, the indication serves as a request for replay data to be transmitted to the device of the second player.

In operation 804, the method 510 can include accessing the compressed version of the user input in response to receiving the indication of operation 802. For example, the user input storage module 320 may access the user input in response to the indication received. The user input storage module 320 may retrieve the user input information via any manner (e.g., via a Representational State Transfer (REST) interface, a binary data format, and the like).

In operation 806, the method 510 can include interpolating or decompressing the compressed version of the user input for playback. For example, the game move interpolation module 330 can generate the interpolated data (also referred to as an “interpolated game move” or “interpolated gesture”) based on the coded data of the compressed user input provided by the user input storage module 320. Interpolation can serve to provide playback gesture information in a format suitable for playback. For example, interpolating a downsampled version of the gesture may provide a smooth simulation of the gesture during playback, and playback may appear smooth and pleasing. Alternatively, in the case that the coded data corresponds to parameters of a function, then the coded data is not in format suitable for direct display. Accordingly, the game move interpolation module 330 can serve to provide playback gesture that has suitable characteristics for playback.

The game move interpolation module 330 can interpolate or decompress the coded data based on any suitable method. For example, a digital interpolation filter can be used to generate the interpolated gesture by processing samples of the coded data generated by down sampling using a fixed sample rate. If the coded data corresponds to parameters of a function curve fitted to the data samples of the gesture, the game move interpolation module 330 can generate the interpolated gesture by evaluating the function using the determine parameters of the coded data. If the coded data corresponds to one of a plurality of template gestures, then the game move interpolation module 330 can generate the interpolated gesture based on the template identified the coded data.

In operation 808, the method 510 can include generating the replay data based at least on the interpolation of operation 806. For example, the user input interface module 310 can generate the replay data by including the interpolated game move of operation 806. Additionally, the replay data may include game move information as well as features of the game move and/or gesture. Features can include various effects such as sound and/or animation. In operation 810, the method 510 can include transmitting replay data. For example the user input interface module 310 can transmit the replay data over the network 106 to the client device of the second user.

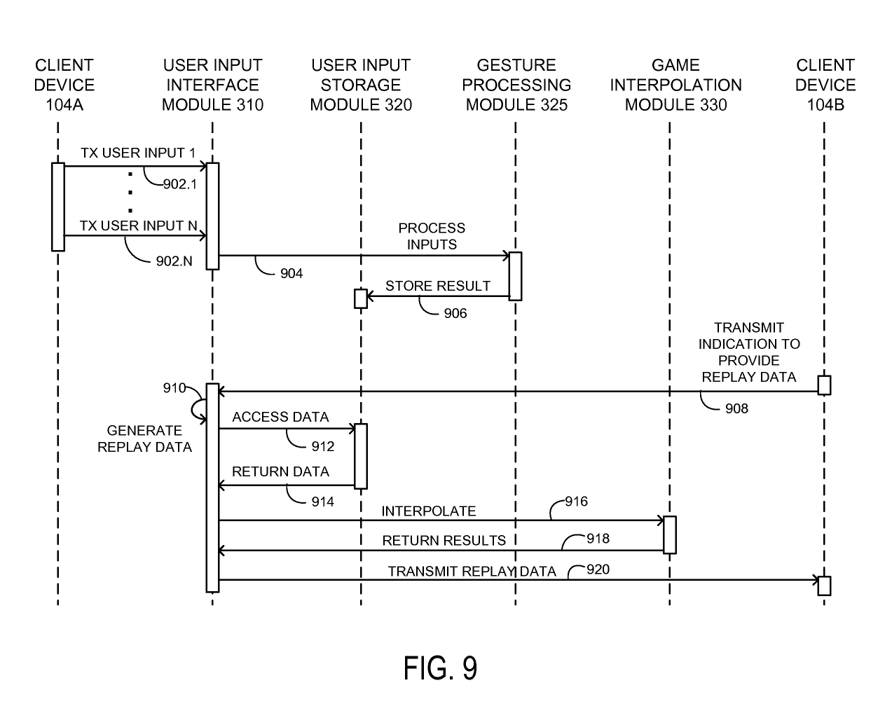

FIG. 9 is an interaction diagram illustrating an example use case 900 of capturing and replaying user gestures made during a game. In particular, FIG. 9 illustrates interactions between various components of the network system 100, according to an example embodiment. Specifically, FIG. 9 illustrates interactions of first and second users (corresponding, e.g., to client devices 104A, 104A), the user input interface module 310, the user input storage module 320, the gesture processing module 325, and the game interpolation module 330.

At operations 902.1, . . . , 902.N, the first client device 104a transmits one or more sets of user inputs to the user input interface module 310. For example, the user inputs can be transmitted in response to a first user of the first client device 104A making game moves by performing one or more gestures. In some embodiments, the user input interface module 310 can receive the user inputs via communications over the network 104. The user inputs can include game move information and/or data samples representative of a gesture made by the first user making a game move.

At operation 904, the user input interface module 310 provides the user inputs to the gesture processing module 325. The gesture or process module 325 can generate a compressed version of the user inputs, as was described above in greater detail in connection with FIG. 7. Additionally, in some embodiments, the gesture processing module 325 can be configured to associate the gesture with one or more features, as was described above in greater detail in connection with FIG. 7. The results of the processing of the gesture processing module 325 are provided, at operation 906, to the user input storage module 324 storing. For example, the user input storage module 320 can be configured to store the compressed version of the user inputs, as well as any associate features, in a database, such as the database 416 of FIG. 4.

At operation 908, the second client device 104B can transmit, to the user input interface module 310, an indication to provide replay data to the second client device 104B. As stated, the indication to me provided in accordance with a scheme for pushing replay data to the second client device 104B and/or for pulling replay data to the second client device 104B.

At operation 910, in response to receiving the indication from the second client device 104B, the user input interface module 310 can initiate a process for generating the replay data requested via the indication. The process for generating the replay data can include operations 912-920. At operation 912, the user input interface module 310 accesses stored data via the user input storage module 320. For example, the stored data can correspond to compressed versions of user inputs generated at operation 904 and stored at operation 906.

At operation 916, in response to accessing the compressed versions of user inputs, the user input interface module 310 can provide the compressed versions of the user inputs to the game interpolation module 334 interpolating the compressed versions of the user inputs. For example, the game interpolation module 330 can process the coded data of the compressed version of the user inputs for generating gesture information at a higher detail than provided by the coded data. At operation 918, the interpolation results are returned and then transmitted as part of the replay data to the second client device 104B. The replay data can be configured to representational simulate, on the second client device 104B, the gesture made by the first player.

### Storing Game-Related Data

A database may store any data relating to game play within a game networking system 108.2. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 108.2 may determine the player's friend preferences based on player attributes that the player's first-degree friends have in common, and may store these player attributes as friend preferences in the player profile. Furthermore, the game networking system 108.2 may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 108.2 may determine the player's likelihood to lead value based on information from other players that interact with this player. For example, the game networking system 108.2 may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 108.2 may also determine the player's likelihood to lead value based on information about the player's interactions with others and the outcome of these interactions. For example, the game networking system 108.2 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108.2 may determine the player's likelihood to lead value based on determining a likelihood for the other players to perform a certain action in response to interacting or communicating with the player and/or the player's virtual environment.

### Example Game Systems, Social Networks, and Social Graphs

In a multiplayer game, players control player characters (PCs), a game engine controls non-player characters (NPCs), and the game engine also manages player character state and tracks states for currently active (e.g., online) players and currently inactive (e.g., offline) players. A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on Player A's team (e.g., the friends that are listed as being in the player's mob/gang/set/army/business/crew/etc. depending on the nature of the game) may be playing the virtual game and choose to confront Player B who has 20 friends on Player B's team. In some embodiments, a player may only have first-degree friends on the player's team. In other embodiments, a player may also have second-degree and higher degree friends on the player's team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

Example Game Networking Systems

A virtual game may be hosted by the game networking system 108.2, which can be accessed using any suitable connection 110 with a suitable client device 104. A player may have a game account on the game networking system 108.2, wherein the game account may contain a variety of information associated with the player (e.g., the player's personal information, financial information, purchase history, player character state, game state, etc.). In some embodiments, a player may play multiple games on the game networking system 108.2, which may maintain a single game account for the player with respect to the multiple games, or multiple individual game accounts for each game with respect to the player. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the client device 104, and/or by the player 102 logging onto the virtual game.

In some embodiments, the player 102 accesses a virtual game and control the game's progress via the client device 104 (e.g., by inputting commands to the game at the client device 104). The client device 104 can display the game interface, receive inputs from the player 102, transmit user inputs or other events to the game engine, and receive instructions from the game engine. The game engine can be executed on any suitable system (such as, for example, the client device 104, the social networking system 108.1, the game networking system 108.2, or the communication system 108.3). For example, the client device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.2.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player is only accessible by that specific player. For example, a first player may access a first game instance when playing a virtual game, and this first game instance may be inaccessible to all other players. In other embodiments, a game instance associated with a specific player is accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player is different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game, and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine interfaces with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in a multiplayer game.

In some embodiments, the social graph is managed by the game networking system 108.2, which is managed by the game operator. In other embodiments, the social graph is part of a social networking system 108.1 managed by a third party (e.g., Facebook, Friendster, Myspace, Yahoo). In yet other embodiments, the player 102 has a social network on both the game networking system 108.2 and the social networking system 108.1, wherein the player 102 can have a social network on the game networking system 108.2 that is a subset, superset, or independent of the player's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the game networking system 108.2, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.1.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network is formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

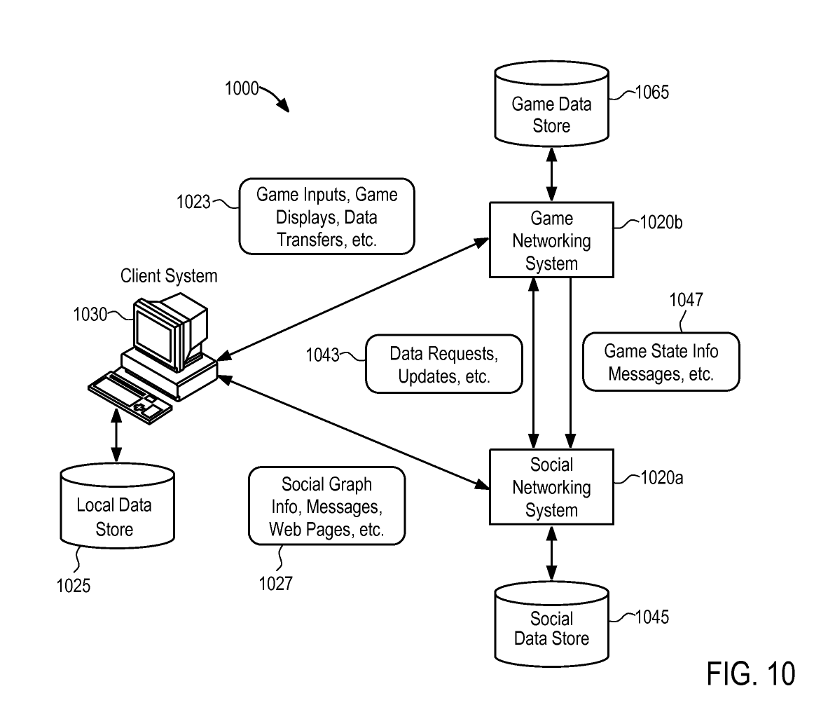

FIG. 10 is a diagrammatic representation of an example data flow between example components of an example system 1000. One or more of the components of the example system 1000 may correspond to one or more of the components of the example system 100. In some embodiments, system 1000 includes a client system 1030, a social networking system 1020a, and a game networking system 1020b. The components of system 1000 can be connected to each other in any suitable configuration, using any suitable type of connection. The components may be connected directly or over any suitable network. The client system 1030, the social networking system 1020a, and the game networking system 1020b may have one or more corresponding data stores such as the local data store 1025, the social data store 1045, and the game data store 1065, respectively.

The client system 1030 may receive and transmit data 1023 to and from the game networking system 1020b. This data can include, for example, a web page, a message, a game input, a game display, a HTTP packet, a data request, transaction information, and other suitable data. At some other time, or at the same time, the game networking system 1020b may communicate data 1043, 1047 (e.g., game state information, game system account information, page info, messages, data requests, updates, etc.) with other networking systems, such as the social networking system 1020a (e.g., FACEBOOK, MYSPACE, etc.). The client system 1030 can also receive and transmit data 1027 to and from the social networking system 1020a. This data can include, for example, web pages, messages, social graph information, social network displays, HTTP packets, data requests, transaction information, updates, and other suitable data.

Communication between the client system 1030, the social networking system 1020a, and the game networking system 1020b can occur over any appropriate electronic communication medium or network using any suitable communications protocols. For example, the client system 1030, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses a virtual game on the game networking system 1020b, the BLOB containing the game state for the instance corresponding to the player may be transmitted to the client system 1030 for use by a client-side executed object to process. In some embodiments, the client-side executable is a FLASH™-based game, which can de-serialize the game state data in the BLOB. As a player plays the game, the game logic implemented at the client system 1030 maintains and modifies the various game state parameters locally. The client-side game logic may also batch game events, such as mouse clicks, and transmit these events to the game networking system 1020b. Game networking system 1020b may itself operate by retrieving a copy of the BLOB from a database or an intermediate memory cache (memcache) layer. The game networking system 1020b can also de-serialize the BLOB to resolve the game state parameters and execute its own game logic based on the events in the batch file of events transmitted by the client to synchronize the game state on the server side. The game networking system 1020b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a player selects one or more actions to perform. The web pages may be displayed in a browser client executed on the client system 1030. For example, a client application downloaded to the client system 1030 may operate to serve a set of web pages to a player. As another example, a virtual game may be an animated or rendered game executable as a stand-alone application or within the context of a webpage or other structured document. In some embodiments, the virtual game is implemented using ADOBE™ FLASH™-based technologies. As an example, a game may be fully or partially implemented as a SWF object that is embedded in a web page and executable by a FLASH™ media player plug-in. In some embodiments, one or more described web pages is associated with or accessed by the social networking system 1020a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at the client system 1030, either caused by an action of a game player or by the game logic itself, the client system 1030 may need to inform the game networking system 1020b of the update. For example, if the game is a farming game with a harvest mechanic (such as ZYNGA™ FARMVILLE™), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as any one of an ADOBE™ FLASH™ object, MICROSOFT™ SILVERLIGHT™ object, HTML 5 object, and the like. FLASH™ may manipulate vector and raster graphics, and supports bidirectional streaming of audio and video. “FLASH™” may mean the authoring environment, the player, or the application files. In some embodiments, the client system 1030 may include a FLASH™ client. The FLASH™ client may be configured to receive and run FLASH™ application or game object code from any suitable networking system (such as, for example, the social networking system 1020a or the game networking system 1020b). In some embodiments, the FLASH™ client is run in a browser client executed on the client system 1030. A player can interact with FLASH™ objects using the client system 1030 and the FLASH™ client. The FLASH™ objects can represent a variety of in-game objects. Thus, the player may perform various in-game actions on various in-game objects by making various changes and updates to the associated FLASH™ objects.

In some embodiments, in-game actions are initiated by clicking or similarly interacting with a FLASH™ object that represents a particular in-game object. For example, a player can interact with a FLASH™ object to use, move, rotate, delete, attack, shoot, or harvest an in-game object. This disclosure contemplates performing any suitable in-game action by interacting with any suitable FLASH™ object. In some embodiments, when the player makes a change to a FLASH™ object representing an in-game object, the client-executed game logic may update one or more game state parameters associated with the in-game object. To ensure synchronization between the FLASH™ object shown to the player at the client system 1030, the FLASH™ client may send the events that caused the game state changes to the in-game object to the game networking system 1020b. However, to expedite the processing and hence the speed of the overall gaming experience, the FLASH™ client may collect a batch of some number of events or updates into a batch file. The number of events or updates may be determined by the FLASH™ client dynamically or determined by the game networking system 1020b based on server loads or other factors. For example, client system 1030 may send a batch file to the game networking system 1020b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to player data or metadata, changes to player social connections or contacts, player inputs to the game, and events generated by the game logic. In some embodiments, each application datum has a name and a value. The value of an application datum may change at any time in response to the game play of a player or in response to the game engine (e.g., based on the game logic). In some embodiments, an application data update occurs when the value of a specific application datum is changed.

In some embodiments, when a player plays a virtual game on the client system 1030, the game networking system 1020b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular player and a particular virtual game. In some embodiments, while a player is not playing the virtual game, the corresponding BLOB may be stored in the database. This enables a player to stop playing the game at any time without losing the current state of the game the player is in. When a player resumes playing the game next time, game networking system 1020b may retrieve the corresponding BLOB from the database to determine the most-recent values of the game-related data. In some embodiments, while a player is playing the virtual game, the game networking system 1020b also loads the corresponding BLOB into a memory cache so that the game system may have faster access to the BLOB and the game-related data contained therein.

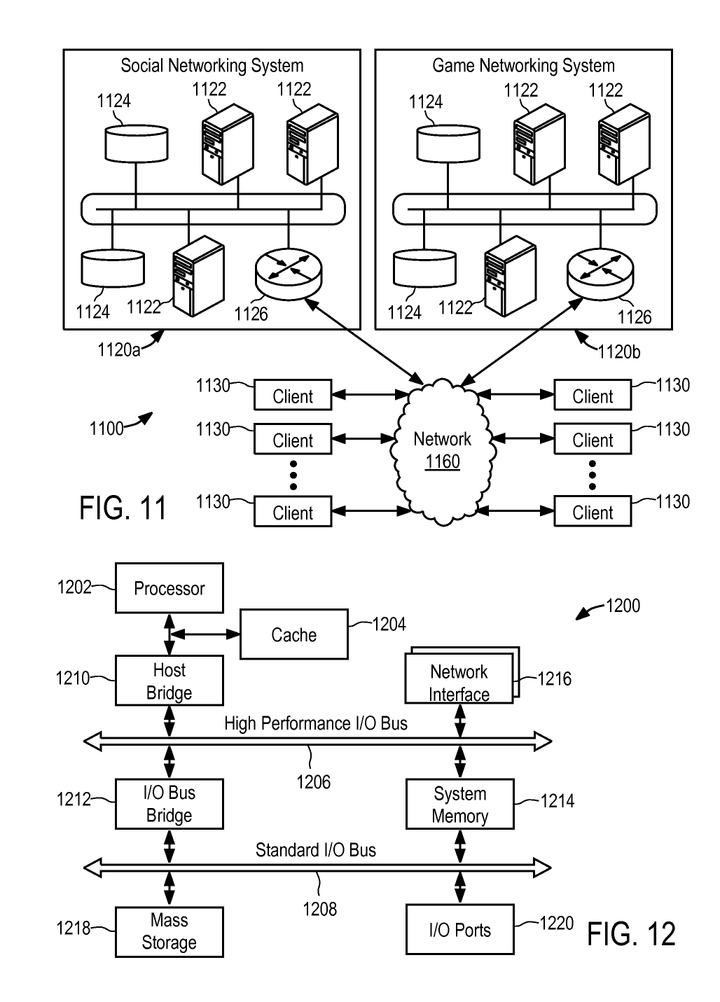

Various embodiments may operate in a wide area network environment, such as the Internet, including multiple network addressable systems. FIG. 11 is a schematic diagram showing an example network environment 1100, in which various example embodiments may operate. Network cloud 1160 generally represents one or more interconnected networks, over which the systems and hosts described herein can communicate. Network cloud 1160 may include packet-based wide area networks (such as the Internet), private networks, wireless networks, satellite networks, cellular networks, paging networks, and the like. As FIG. 11 illustrates, various embodiments may operate in a network environment 1100 comprising one or more networking systems, such as a social networking system 1120a, a game networking system 1120b, and one or more client systems 1130. The components of the social networking system 1120a and the game networking system 1120b operate analogously; as such, hereinafter they may be referred to simply as the networking system 1120. The client systems 1130 are operably connected to the network environment 1100 via a network service provider, a wireless carrier, or any other suitable means.

The networking system 1120 is a network addressable system that, in various example embodiments, comprises one or more physical servers 1122 and data stores 1124. The one or more physical servers 1122 are operably connected to computer network cloud 1160 via, by way of example, a set of routers and/or networking switches 1126. In an example embodiment, the functionality hosted by the one or more physical servers 1122 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), XML, Java, JavaScript, Asynchronous JavaScript and XML (AJAX), FLASH™, ActionScript, and the like.

The physical servers 1122 may host functionality directed to the operations of the networking system 1120. Hereinafter servers 1122 may be referred to as server 1122, although the server 1122 may include numerous servers hosting, for example, the networking system 1120, as well as other content distribution servers, data stores, and databases. Data store 1124 may store content and data relating to, and enabling, operation of, the networking system 1120 as digital data objects. A data object, in some embodiments, is an item of digital information typically stored or embodied in a data file, database, or record. Content objects may take many forms, including: text (e.g., ASCII, SGML, HTML), images (e.g., JPEG, TIF and GIF), graphics (vector-based or bitmap), audio, video (e.g., MPEG), or other multimedia, and combinations thereof. Content object data may also include executable code objects (e.g., games executable within a browser window or frame), podcasts, and the like.

Logically, data store 1124 corresponds to one or more of a variety of separate and integrated databases, such as relational databases and object-oriented databases, that maintain information as an integrated collection of logically related records or files stored on one or more physical systems. Structurally, data store 1124 may generally include one or more of a large class of data storage and management systems. In some embodiments, data store 1124 may be implemented by any suitable physical system(s) including components, such as one or more database servers, mass storage media, media library systems, storage area networks, data storage clouds, and the like. In one example embodiment, data store 1124 includes one or more servers, databases (e.g., MySQL), and/or data warehouses. Data store 1124 may include data associated with different networking system 1120 users and/or client systems 1130.

The client system 1130 is generally a computer or computing device including functionality for communicating (e.g., remotely) over a computer network. The client system 1130 may be a desktop computer, laptop computer, personal digital assistant (PDA), in- or out-of-car navigation system, smart phone or other cellular or mobile phone, or mobile gaming device, among other suitable computing devices. Client system 1130 may execute one or more client applications, such as a Web browser.

When a user at a client system 1130 desires to view a particular webpage (hereinafter also referred to as target structured document) hosted by the networking system 1120, the user's web browser, or other document rendering engine or suitable client application, formulates and transmits a request to the networking system 1120. The request generally includes a URL or other document identifier as well as metadata or other information. By way of example, the request may include information identifying the user, a timestamp identifying when the request was transmitted, and/or location information identifying a geographic location of the user's client system 1130 or a logical network location of the user's client system 1130.

Although the example network environment 1100 described above and illustrated in FIG. 11 is described with respect to the social networking system 1120a and the game networking system 1120b, this disclosure encompasses any suitable network environment using any suitable systems. For example, a network environment may include online media systems, online reviewing systems, online search engines, online advertising systems, or any combination of two or more such systems.

FIG. 12 is a block diagram illustrating an example computing system architecture, which may be used to implement a server 1122 or a client system 1130. In one embodiment, the hardware system 1200 comprises a processor 1202, a cache memory 1204, and one or more executable modules and drivers, stored on a tangible computer-readable storage medium, directed to the functions described herein. Additionally, the hardware system 1200 may include a high performance input/output (I/O) bus 1206 and a standard I/O bus 1208. A host bridge 1210 may couple the processor 1202 to the high performance I/O bus 1206, whereas the I/O bus bridge 1212 couples the two buses 1206 and 1208 to each other. A system memory 1214 and one or more network/communication interfaces 1216 may couple to the bus 1206. The hardware system 1200 may further include video memory (not shown) and a display device coupled to the video memory. Mass storage 1218 and I/O ports 1220 may couple to the bus 1208. The hardware system 1200 may optionally include a keyboard, a pointing device, and a display device (not shown) coupled to the bus 1208. Collectively, these elements are intended to represent a broad category of computer hardware systems.

The elements of the hardware system 1200 are described in greater detail below. In particular, the network interface 1216 provides communication between the hardware system 1200 and any of a wide range of networks, such as an Ethernet (e.g., IEEE 802.3) network, a backplane, and the like. The mass storage 1218 provides permanent storage for the data and programming instructions to perform the above-described functions implemented in servers 1122 of FIG. 11, whereas system memory 1214 (e.g., DRAM) provides temporary storage for the data and programming instructions when executed by the processor 1202. I/O ports 1220 are one or more serial and/or parallel communication ports that provide communication between additional peripheral devices, which may be coupled to the hardware system 1200.

The hardware system 1200 may include a variety of system architectures and various components of the hardware system 1200 may be rearranged. For example, cache memory 1204 may be on-chip with the processor 1202. Alternatively, the cache memory 1204 and the processor 1202 may be packed together as a “processor module,” with processor 1202 being referred to as the “processor core.” Furthermore, certain embodiments of the present disclosure may neither require nor include all of the above components. For example, the peripheral devices shown coupled to the standard I/O bus 1208 may couple to the high performance I/O bus 1206. In addition, in some embodiments, only a single bus may exist, with the components of the hardware system 1200 being coupled to the single bus. Furthermore, the hardware system 1200 may include additional components, such as additional processors, storage devices, or memories.

An operating system manages and controls the operation of the hardware system 1200, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method for providing replay data, the method comprising:
receiving, from a first client device of a first user, user input including a plurality of data samples representative of a gesture made by a first user making a game move;
generating, by one or more processors, a compressed version of the user input, the compressed version including coded data representative of the plurality of data samples, the coded data having a smaller data size than the plurality of data samples; and
providing, to a second client device of a second user, replay data that is based on the compressed version of the user input, the replay data being configured to simulate, at the second device, the gesture made by the first user.

2. The computer-implemented method of claim 1, wherein generating the compressed version of the user input comprises generating the coded data by selecting a subset of the plurality of data samples.

3. The computer-implemented method of claim 1, wherein generating the compressed version of the user input comprises generating the coded data by selecting two or more data samples of the plurality of data samples that are representative of locations about which the gesture interacted with objects displayed within the game.

4. The computer-implemented method of claim 1, wherein generating the compressed version of the user input comprises:
determining one or more parameters of a function based on comparing evaluations of the function to two or more of the plurality of data samples, the coded data including the determined one or more parameters.

5. The computer-implemented method of claim 1, further comprising:
interpolating the coded data to generate an interpolated game move, the replay data including the interpolated game move.

6. The computer-implemented method of claim 1, further comprising:
storing the compressed version of the user input; and
receiving, from the second client device, an indication to provide replay data to the second client device, providing the reply data being in response to receiving the indication.

7. The computer-implemented method of claim 1, wherein the user input further includes game move information indicative of the game move, the game move being associated with the movement of a game object the first user moved in the game.

8. The computer-implemented method of claim 1, wherein the gesture includes any one or any combination of the following: an orientation of the first client device, a movement of the first client device, a movement of the first user of a surface of the first client device, or a manner in which the first user provides the first user input.

9. The computer-implemented method of claim 1, wherein the replay data includes an indication of a feature associated with the gesture made by the first user, the feature including at least one of a sound or an animation.

10. The computer-implemented method of claim 1, further comprising:
storing a first data sample of the plurality of data samples;
comparing the first data sample to a second data sample of the plurality of data samples; and
storing the second data sample if the comparison of the first data sample and the second data sample is greater than a threshold.

11. The computer-implemented method of claim 1, furthering comprising:
determining a relevance of the plurality of data samples to the gesture; and
storing one or more of the plurality of data samples based at least on the determined relevance of the plurality of data samples to the gesture.

12. The computer-implemented method of claim 11, wherein the user input further includes game move information indicative of the game move, determining the relevance comprising comparing the plurality of data samples to the game move information.

13. A computer-readable storage medium storing instructions which, when executed by one or more processors, cause the one or more processors to perform operations, comprising:
receiving, from a first client device of a first user, user input including a plurality of data samples representative of a gesture made by a first user making a game move;
generating a compressed version of the user input, the compressed version including coded data representative of the plurality of data samples, the coded data having a smaller data size than the plurality of data samples; and
providing, to a second client device of a second user, replay data that is based on the compressed version of the user input, the replay data being configured to representationally simulate, at the second device, the gesture made by the first user.

14. The computer-readable storage medium of claim 13, wherein generating the compressed version of the user input comprises generating the coded data by selecting a subset of the plurality of data samples.

15. The computer-readable storage medium of claim 13, wherein generating the compressed version of the user input comprises generating the coded data by selecting two or more data samples of the plurality of data samples that are representative of locations about which the gesture interacted with objects displayed within the game.

16. The computer-readable storage medium of claim 13, further storing instructions which, when executed by the one or more processors, causes the one or more processors to perform operations comprising:
interpolating the coded data to generate an interpolated game move, the replay data including the interpolated game move.

17. The computer-readable storage medium of claim 13, further storing instructions which, when executed by the one or more processors, causes the one or more processors to perform operations comprising:
storing a first data sample of the plurality of data samples;
comparing the first data sample to a second data sample of the plurality of data samples; and
storing the second data sample if the comparison of the first user input and the second user input is greater than a threshold.

18. A game networking system, comprising:
a hardware-implemented user input module configured to receive, from a first client device of a first user, user input including a plurality of data samples representative of a gesture made by a first user making a game move;
a hardware-implemented gesture processing module configured to generate a compressed version of the user input, the compressed version including coded data representative of the plurality of data samples, the coded data having a smaller data size than the plurality of data samples; and
a hardware-implemented display module configured to provide, to the second client device of a second user, replay data that is based on the compressed version of the user input, the replay data being configured to representationally simulate, at the second device, the gesture made by the first user.

19. The game networking system of claim 18, wherein a hardware-implemented gesture processing module is further configured to generate the compressed version of the user input by generating the coded data by selecting a subset of the plurality of data samples.

20. The game networking system of claim 18, further comprising a hardware-implemented move interpolation module configure to generate an interpolated game move by interpolating the coded data, the replay data including the interpolated game move.
